(19) United States
(12) Patent Application Publication
(10) Pub. No.: US 2026/0350844 A1
(43) Pub. Date: Nov. 5, 2026

(54) METHODS AND SYSTEMS FOR COMPRESSION OF 3D GAUSSIAN SPLATTING DATA

(71) Applicant: Huawei Technologies Co., Ltd., Shenzhen (CN)

(72) Inventors: Yang Liu, Richmond Hill (CA); Keyi Liu, Ottawa (CA); Mohamed Ibrahim Hafez Ibrahim, Ottawa (CA); Shuja Khalid, Ottawa (CA); Shufang Lu, Ottawa (CA); Yehor Polshcha, Ottawa (CA)

(21) Appl. No.: 19/195,368

(22) Filed: Apr. 30, 2025

(51) Int. Cl. G06T 9/00; G06T 3/06

(52) U.S. Cl. CPC G06T 9/00; G06T 3/06

(57) ABSTRACT

Methods and systems for compression of 3DGS data are disclosed. A set of quantized values is generated from spherical harmonics data of a 3D Gaussian splatting (3DGS) data structure. The set of quantized values is preprocessed into a 2D layout that corresponds to a 2D texture format. The set of quantized values in the 2D layout is compressed, using 2D texture compression that is compatible with the 2D texture format, into a compressed 2D texture format that is supported by hardware of a graphics processing unit (GPU), to obtain compressed data. The compressed data can be decompressed, by the hardware of the GPU, using 2D texture decompression to obtain a set of recovered quantized values. Recovered spherical harmonics data can be obtained from the set of recovered quantized values and a 3D scene can be rendered using the recovered spherical harmonics data.

### FIELD

The present disclosure relates to methods and systems for data compression, in particular compression of 3D Gaussian splatting spherical harmonics data.

### BACKGROUND

Radiance field techniques have been studied as a way to construct a 3D scene using a set of 2D images. This has reduced the 3D reconstruction cost compared to traditional 3D scene construction techniques, and has enabled various applications, such as virtual scene navigation, product display, and 3D simulation for autonomous driving and embodied artificial intelligence (AI), among others.

3D Gaussian splatting (3DGS) is a technique for radiance field representation, which has shown promise over other radiance field representations such as neural radiance field (NeRF). 3DGS has some advantages over NeRF, such as faster reconstruction, real-time rendering and the ability to leverage existing graphics processing unit (GPU) rasterization hardware pipelines. However, 3DGS data typically requires a large amount of memory resources.

Accordingly, there is a need for improvements in compression of 3DGS data.

### SUMMARY

Some embodiments of the present disclosure include one or more of the following features, which can be separately adopted, or work together as a complete solution.

In various examples, the present disclosure describes methods and systems for compression of 3DGS data, particularly compression of spherical harmonics data in the 3DGS data structure. Examples of the present disclosure provide a technical advantage in that the compressed data can be processed using random access, which may result in consuming less processing resources (e.g., less virtual random access memory (VRAM) consumption), compared to conventional solutions.

By preprocessing quantized values (e.g., vector quantization (VQ) indices) of the spherical harmonics data into a 2D layout and then compressing the 2D layout using texture processing, examples of the present disclosure may leverage existing capabilities of GPU hardware for 2D texture processing. This enables decompression to be performed using the GPU hardware, which may provide a technical advantage in that processing can be done more efficiently (e.g., using less time, less power resources, less processing resources, etc.) compared to conventional solutions that rely on programmable shader calculations, for example. GPU hardware may be used to efficiently decompress the 3DGS data, which may then be used directly for inverse quantization processes, without the need to store data in VRAM, thus reducing consumption of memory and processing resources. As well, compression of 3DGS data as disclosed herein may also help to reduce usage of storage and transmission resources.

In some examples preprocessing quantized values may include sorting the quantized values to increase the 2D spatial correlation in the 2D layout. This may help to reduce information loss during compression, which may provide improved performance (e.g., fewer artifacts) when subsequently decompressed and the recovered spherical harmonics are used for 3D rendering. Examples of the present disclosure may support various 2D texture compression formats, including BCn, BC7 and ASTC, without limitation.

In some examples, the present disclosure describes a rendering system that is configured to compress 3DGS data representing a 3D scene, using quantization (e.g., VQ) and 2D texture processing. The example rendering system provides technical advantages over conventional systems by reducing usage of memory resources (e.g., VRAM resources) by leveraging GPU texture processing hardware to enable random data access.

Additional details of the disclosed examples and technical advantages thereof will be described further below.

In an example aspect, the present disclosure describes a method including: generating a set of quantized values from spherical harmonics data of a 3D Gaussian splatting (3DGS) data structure; preprocessing the set of quantized values into a 2D layout that corresponds to a 2D texture format; compressing the set of quantized values in the 2D layout, using 2D texture compression that is compatible with the 2D texture format, into a compressed 2D texture format that is supported by hardware of a graphics processing unit (GPU), to obtain compressed data; and storing the compressed data.

In an example of the preceding example aspect of the method, the method may further include: decompressing, by the hardware of the GPU, the compressed quantized values using 2D texture decompression to obtain a set of recovered quantized values; obtaining recovered spherical harmonics data from the set of recovered quantized values; and rendering a 3D scene using the recovered spherical harmonics data.

In an example of the preceding example aspect of the method, the set of quantized values may be a set of vector quantization (VQ) indices generated using VQ, the set of recovered quantized values may be a set of recovered VQ indices, the recovered spherical harmonics data may be recovered using inverse VQ on the recovered VQ indices, and a codebook used for generating the set of VQ indices may be also used for performing the inverse VQ.

In an example of some of the preceding example aspects of the method, rendering the 3D scene may include: obtaining other data of the 3DGS data structure; obtaining viewpoint data representing a viewpoint; and rendering the 3D scene corresponding to the viewpoint using the recovered spherical harmonics data, the other data of the 3DGS data structure and the viewpoint data.

In an example of some of the preceding example aspects of the method, the hardware of the GPU may decompress the compressed data using random data access.

In an example of any of the preceding example aspects of the method, preprocessing the set of quantized values may include: sorting the quantized values, wherein the quantized values in the 2D layout are sorted numerically.

In an example of any of the preceding example aspects of the method, the 2D layout may be selected to have a size large enough to store the set of quantized values.

In an example of any of the preceding example aspects of the method, preprocessing the set of quantized values may include: encoding each quantized value in the set of quantized values into an RGB value.

In an example of any of the preceding example aspects of the method, the 2D texture compression may be a block compression.

In an example of the preceding example aspect of the method, the block compression may be one of: any one of block compression (BC) BC1 to BC7; adaptive scalable texture compression (ASTC); or any one of DirectX Texture (DXT) DXT1 to DXT3.

In an example of any of the preceding example aspects of the method, the method may further include: obtaining the 3DGS data structure from a set of 2D images.

In another example aspect, the present disclosure describes a computing system including a non-transitory memory; and a processing unit configured to execute instructions stored in the non-transitory memory to cause the system to: generate a set of quantized values from spherical harmonics data of a 3D Gaussian splatting (3DGS) data structure; preprocess the set of quantized values into a 2D layout that corresponds to a 2D texture format; compress the set of quantized values in the 2D layout, using 2D texture compression that is compatible with the 2D texture format, into a compressed 2D texture format that is supported by hardware of a graphics processing unit (GPU), to obtain compressed data; and store the compressed data.

In an example of the preceding example aspect of the system, the processing unit may be configured to execute the instructions to further cause the system to: decompress, by the hardware of the GPU, the compressed data using 2D texture decompression to obtain a set of recovered quantized values; obtain recovered spherical harmonics data from the set of recovered quantized values; and render a 3D scene using the recovered spherical harmonics data.

In an example of the preceding example aspect of the system, the set of quantized values may be a set of vector quantization (VQ) indices generated using VQ, the set of recovered quantized values may be a set of recovered VQ indices, the recovered spherical harmonics data may be recovered using inverse VQ on the recovered VQ indices, and wherein a codebook used for generating the set of VQ indices is also used for performing the inverse VQ.

In an example of some of the preceding example aspects of the system, the processing unit may be configured to execute the instructions to cause the system to render the 3D scene by: obtaining other data of the 3DGS data structure; obtaining viewpoint data representing a viewpoint; and rendering the 3D scene corresponding to the viewpoint using the recovered spherical harmonics data, the other data of the 3DGS data structure and the viewpoint data.

In an example of some of the preceding example aspects of the system, the hardware of the GPU may decompress the compressed data using random data access.

In an example of any of the preceding example aspects of the system, the processing unit may be configured to execute the instructions to cause the system to preprocess the set of quantized values by: sorting the quantized values, wherein the quantized values in the 2D layout are sorted numerically.

In an example of any of the preceding example aspects of the system, the processing unit may be configured to execute the instructions to cause the system to preprocess the set of quantized values by: encoding each quantized value in the set of quantized values into an RGB value.

In an example of any of the preceding example aspects of the system, the 2D texture compression may be a block compression that may be one of: any one of block compression (BC) BC1 to BC7; adaptive scalable texture compression (ASTC); or any one of DirectX texture (DXT) DXT1 to DXT3.

In another example aspect, the present disclosure describes a non-transitory computer readable medium storing instructions thereon, wherein the instructions are executable by a processing unit of a computing system to cause the system to: generate a set of quantized values from spherical harmonics data of a 3D Gaussian splatting (3DGS) data structure; preprocess the set of quantized values into a 2D layout that corresponds to a 2D texture format; compress the set of quantized values in the 2D layout, using 2D texture compression that is compatible with the 2D texture format, into a compressed 2D texture format that is supported by hardware of a graphics processing unit (GPU), to obtain compressed data; and store the compressed data.

In an example of the preceding example aspect of the computer readable medium, the instructions, when executed by a processing unit of a system, may cause the system to perform any of the preceding example aspects of the method.

In another example aspect, the present disclosure describes a processing module configured to control a computing system to cause the system to carry out any of the preceding example methods.

In another example aspect, the present disclosure describes a chip or a chipset comprising a processor configured to execute instructions to cause a computing system to carry out any of the preceding example methods.

In another example aspect, the present disclosure describes a computer program characterized in that, when the computer program is run on a computer, the computer is caused to execute any of the preceding example methods.

### BRIEF DESCRIPTION OF THE DRAWINGS

Reference will now be made, by way of example, to the accompanying drawings which show example embodiments of the present application, and in which:

FIG. 1 is a representation of an example 3DGS data structure;

FIG. 2 is a block diagram illustrating an example computing system, which may be used to implement examples of the present disclosure;

FIG. 3 is a schematic diagram illustrating an example 3D rendering process using 3DGS, in accordance with examples of the present disclosure;

FIG. 4 is a flowchart illustrating an example method for compressing spherical harmonics data of a 3DGS data structure, in accordance with examples of the present disclosure; and

FIG. 5 is a flowchart illustrating an example method for rendering a 3D scene from compressed data, in accordance with examples of the present disclosure.

Similar reference numerals may have been used in different figures to denote similar components.

### DETAILED DESCRIPTION

In various examples, the present disclosure describes methods and systems for compression of 3DGS data. 3DGS is a technique for rendering a 3D scene from a set of 2D images, using radiance field techniques. While 3DGS has advantages over other radiance field techniques such as NeRF, a challenge with 3DGS is that 3DGS data typically requires a large amount of memory to store.

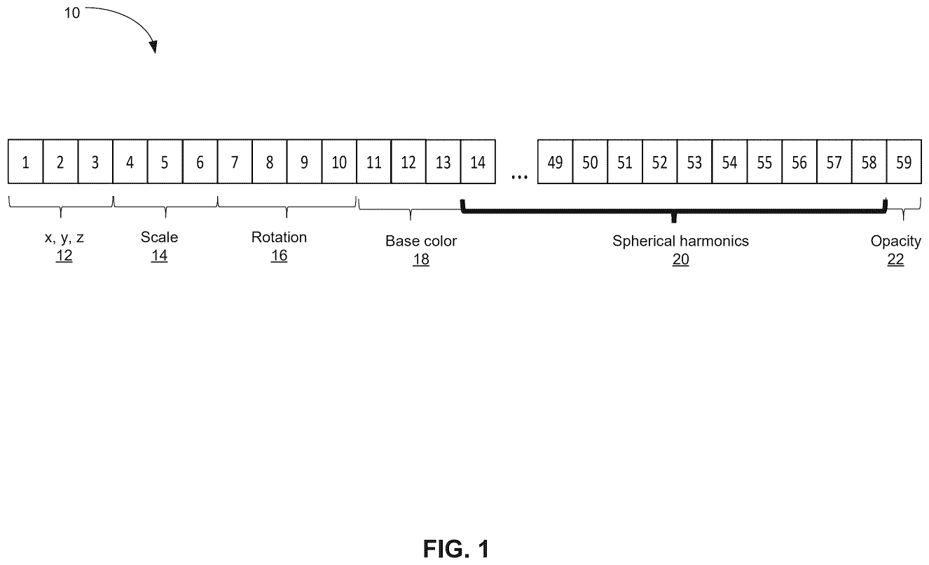

FIG. 1 illustrates an example of 3DGS data structure 10. The 3DGS data structure 10 includes data for 59 attributes, including 3 data attributes for the x, y, z coordinates 12, 3 data attributes for scale 14, 3 data attributes for rotation 16, 3 data attributes for base color 18, 45 data attributes for spherical harmonics 20, and 1 data attribute for opacity 22. Each data attribute typically is stored using fp32 floating point format, requiring 4 bytes of storage each. This means that a single 3DGS data structure 10 would require about 236 bytes of storage.

Considering that a typical 3D scene may be represented using 6 million Gaussians, this means that about 1.4 GB of storage would be required to store the 3DGS data for that scene. This is a significant usage of memory and limits practical application.

Reducing the size of 3DGS data would be useful for practical large scale scene rendering, improving real-time performance, saving memory resources, reducing transmission bandwidth and reducing VRAM usage, among other benefits.

As illustrated in FIG. 1, it can be seen that a large portion of the 3DGS data are spherical harmonics data. In particular, 45 of the 59 data attributes in the 3DGS data structure are parameters for the spherical harmonics. In examples of the present disclosure a technique for compression of the spherical harmonics data is provided, which significantly compresses the overall 3DGS data size.

Some discussion of existing solutions for 3DGS data compression is first provided.

An existing solution is to use VQ with codebook to compress spherical harmonics data in the 3DGS data structure. After the VQ index is generated for each Gaussian, the VQ indices can be transferred to GPU VRAM directly for inverse VQ. However, the VQ indices is typically still a large amount of data, which can be challenging for large scenes and real-time rendering. Thus, in some existing solutions, the VQ indices may be compressed using a 3D data compression technique such as run-length encoding.

However, 1D compression used in existing solutions cannot provide random access to the compressed data. To support random access, the data would need to be decompressed and stored in VRAM. Thus, there is significant VRAM usage involved, which means significant memory resources are consumed. Further, decompression of 1D compressed data typically requires the GPU to perform shader calculations, which can lead to latency that is undesirable for real-time rendering and other latency-sensitive rendering tasks.

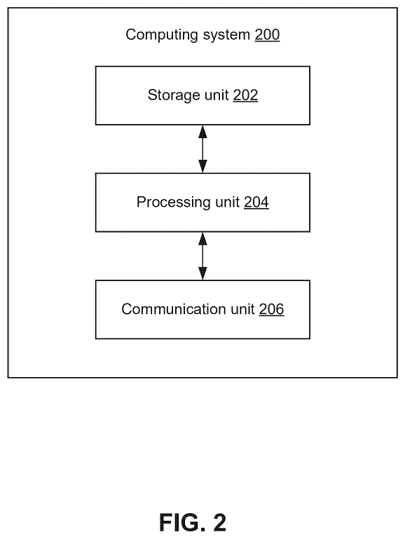

Examples of the present disclosure provide improved 3DGS compression by using 2D texture processing that is supported by GPU hardware. Reference is now made to FIG. 2, illustrating an example computing system.

FIG. 2 is a block diagram of an example computing system 200, which may be used to implement examples of the present disclosure. The example computing system 200 may, for example, be a desktop computer, a workstation, a laptop, a terminal, etc. In some examples, the computing system 200 may be a module or subsystem within a larger system. FIG. 2 intended to be illustrative, and examples of the present disclosure may be implemented using other types of computing systems, which may include components different from those discussed below.

Although FIG. 2 shows a single instance of each component, there may be multiple instances of each component in the computing system 200 The computing system 200 may include corresponding modules or units configured to implement methods and/or implementations described herein. In the example shown, the computing system 200 includes a processing unit 204 and a communication unit 206. The computing system 200 may further include a storage unit 202 configured to store apparatus program code (or instructions) and/or data (such as instructions for carrying out examples disclosed herein).

The processing unit 204 may be one or more processors, including at least one graphics processing unit (GPU). The processing unit 204 may further include another processor may such as a modem chip, a System on a Chip (SoC) or a System in Packet (SiP), among other possibilities. In some examples, the processing unit 204 may be implemented by a circuit system which may include one or more processors. A processor may be referred to as a processor system, an application processor, a baseband processor, a processor circuit, or a processor core. The processor may include one or a combination of one or more central processing units (CPUs), one or more digital signal processors (DSPs), one or more microprocessors (microprocessor units, MPUs), one or more microcontrollers (microcontroller units, MCUs), one or more GPUs, or one or more field programmable gate arrays (FPGAs).

The communication unit 206 may include wireless transmitters and/or receivers (or transceivers). In some examples, the communication unit 206 may be implemented by an interface circuit.

The storage unit 202 may be a memory. A memory or a storage unit may include one or more of the following storage media: a random access memory (RAM), a static random access memory (static RAM, SRAM), a dynamic random access memory (dynamic RAM, DRAM), a phase-change memory (PCM), a resistive random access memory (resistive RAM, ReRAM), a magnetoresistive random access memory (magnetoresistive RAM, MRAM), a ferroelectric random access memory (ferroelectric RAM, FRAM), a cache, a register, a read-only memory (ROM), a flash memory (flash memory), an erasable programmable read-only memory (erasable programmable ROM, EPROM), a hard disk, and the like. The computing system 200 may also use a VRAM. The storage unit 202 may store instructions that are executable by the processing unit 204, to perform one or more examples of the present disclosure.

In an example, computer program instructions used to execute implementations may be stored in a non-volatile memory, for example, at least a part of a memory or storage unit (for example, one or more of a ROM, a flash memory, an EPROM, or a hard disk). When the computing system 200 runs, a part or all of corresponding computer program instructions may be loaded to a memory that has a higher transmission speed with the processor, for example, at least a part of a memory or a storage unit (for example, one or more of a RAM, an SRAM, a DRAM, a PCM, a RERAM, an MRAM, a FRAM, a cache, or a register), so that the processor executes the computer program instructions to perform the steps in the example method implementations disclosed herein.

It should be understood that the units 202, 204, 206 in the computing system 200 may be a combination of logical units and functional units. For example, each function may correspond to one functional unit, or two or more functions may be integrated into a single functional unit. In actual implementation, all or some of the units may be integrated into a single physical entity, or may be distributed across different physical entities. In addition, the functional units may be implemented in the form of hardware, software, or a combination of hardware and software. Whether a function is implemented in the form of hardware or software depends on particular applications and design constraint conditions of the technical solutions. A person skilled in the art may use different methods to implement the described functions for specific applications, but it should not be considered that the implementation goes beyond the scope of this disclosure.

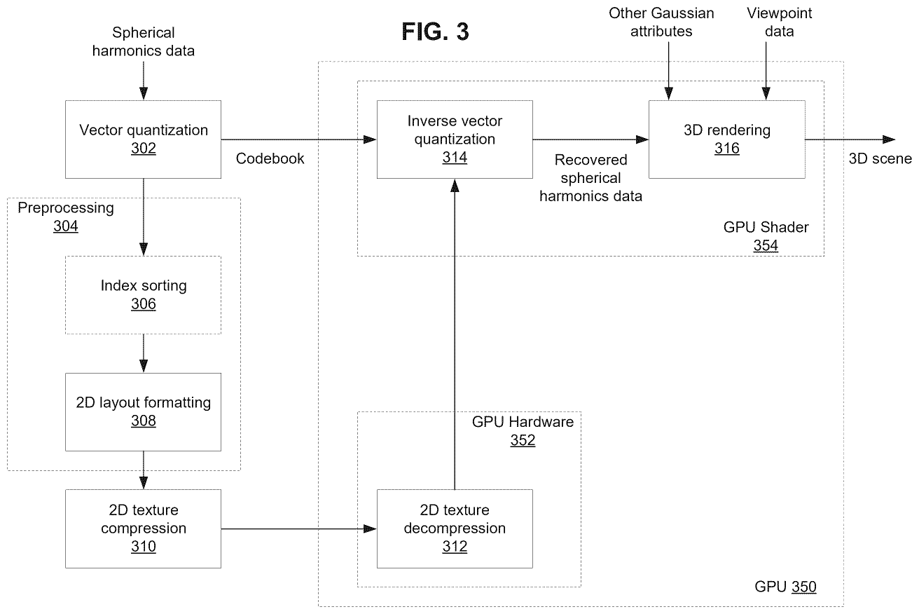

FIG. 3 is a schematic diagram illustrating an example 3D rendering process using 3DGS, including 3DGS data compression, in accordance with examples of the present disclosure. FIG. 3 illustrates functional blocks that may be executed by the processing unit 204 (e.g., CPU and GPU) of the computing system 200. It should be understood that these functional blocks may be implemented using any suitable logic, for example two or more functional blocks shown in FIG. 3 may be carried out as a single function.

In the example of FIGS. 3, 3DGS data has been obtained using any suitable means (e.g., generated from a set of 2D images). The pipeline shown in FIG. 3 processes the spherical harmonics data attributes of a 3DGS data structure.

Functional blocks 302-310 may be performed in the processing unit 204 outside of the GPU 350 (e.g., may be performed by the CPU). The spherical harmonics are then quantized using a suitable quantization technique, such as scalar quantization, VQ, etc. In the example shown, VQ is used however this is not intended to be limiting. During VQ 302, the spherical harmonics data is quantized with VQ using a codebook. Various techniques may be used to design the codebook for VQ of the spherical harmonics data. An example of codebook design is described below, however this is only illustrative and not intended to be limiting.

For example, given a 3DGS scene with N Gaussians, the data may be stored in a file (e.g., PLY file) containing a 2D array of shape (N, 59) (i.e., N Gaussians, each represented by a data structure having 59 data attributes). The portion of data to be compressed are the spherical harmonics with shape (N, 45), which is approximately 76.3% of the whole dataset. A set of C clusters is determined (e.g., learned) from all N Gaussians, and a cluster index (also referred to as cluster ID) is assigned per Gaussian as well as global cluster centroids of shape (C, 45). Close-by Gaussians within the cluster will be using the same cluster ID, and thus the same set of coefficients. Cluster centroids may be stored in a float 2D array of shape (C, 45). 16-bit data may be used to support up to 65,536 clusters. VQ indices, which are the cluster indices, may be stored as a 16-bit unsigned integer 1D array of shape (N, 1). This may be further encoded into 2 8-bit unsigned integers, resulting a shape of (N, 2), where the first element of each row is the quotient of ID/256, and the second element is the remainder.

The codebook may be transmitted to the GPU 350 for subsequent inverse VQ.

The VQ indices generated from VQ 302 may be preprocessed in the preprocessing block 304. If another quantization technique is used instead of VQ 302, the quantized values from quantization may be preprocessed in the preprocessing block 304. Preprocessing 304 causes the VQ indices (or other quantized values, if a quantization technique other than VQ is used) to be formatted into a format that can be processed as a 2D texture. Preprocessing of the VQ indices includes 2D layout formatting 308. Optionally, the preprocessing 304 may include index sorting 306 prior to 2D layout formatting 308.

The optional index sorting 306 sorts the Gaussians based on the VQ indices. As a result, the resulting data is ordered by increasing or decreasing value. For example, the resulting data after index sorting 306 may be 0, 0, 0, 1, 1, 1, . . . . . . , c-1, c-1. Index sorting 306 may help to reduce information loss during compression by increasing the spatial correlation between data points in the 2D layout. However, in some cases (e.g., in certain applications that are less sensitive to information loss) index sorting 306 may be omitted to speed up 3D rendering.

The 2D layout formatting 308 serves to format the VQ indices into 2D layout that can be compressed into a compressed 2D texture format supported by the hardware of the GPU 350. For example, 2D layout formatting 308 may first convert each VQ index into a data format that is compatible with 2D texture processing (e.g., each VQ index is converted into a corresponding RGB value). In an example, each VQ index is encoded into two 8-bit unsigned integers that are stored in the red and green channels of an RGB texture (e.g., the VQ index may be divided by 256 and the resulting quotient may be stored in the red channel while the remainder is stored in the green channel). Other methods may be used to format the VQ indices. In general, each VQ index is processed so that it appears similar to data in a 2D texture file (e.g., RGB data).

The 2D layout formatting 308 further processes the VQ indices by arranging the VQ indices into a 2D layout (e.g., a 2D data array) that is similar to 2D texture data (e.g., similar to 2D layout of pixels in a 2D texture). The 2D layout may have a texture size that is has a texture width and texture height that is large enough to store all the VQ indices (i.e., width*height≥N, where N is the number of VQ indices) as a single 2D texture. The 2D layout should be one that can be compressed using 2D texture processing into a compressed 2D texture format supported by the hardware of the GPU 350. The result of the preprocessing 304 is that the VQ indices (which may be encoded into RGB values) are arranged in a 2D layout, which may be referred to as the 2D layout of VQ indices for convenience.

Although the optional index sorting 306 and the 2D layout formatting 308 are shown as separate functional blocks and in a particular order, it should be understood that the optional index sorting 306 and the 2D layout formatting 308 may, in some cases, be performed together as a single functional block and/or in a different order within the preprocessing 304 block.

Following the preprocessing 304, 2D texture compression 310 is carried out on the 2D layout of VQ indices. Any suitable 2D texture compression technique that compresses a 2D texture into a format supported by the hardware of the GPU 350 may be used. For example, any one of block compression (BC) formats BC1 to BC7 (also referred to generically as BCn), adaptive scalable texture compression (ASTC), or DirectX texture (DXT) formats DXT1 to DXT3 may be used to compress the 2D layout VQ indices. For example, if BC7 format is used, the 2D layout VQ indices are saved as 4×4 blocks of data.

The compressed data resulting from the 2D texture compression 310 may be stored in memory (e.g., in the storage unit 202 of the computing system 200) and/or in a remote storage (e.g., in a database remote from the computing system 200) as a compressed 2D texture file. The compressed data may be retrieved from memory (or other storage) and provided to the GPU 350 to be used for rendering a 3D scene.

The GPU 350 processes the compressed data using GPU hardware 352 and GPU shader 354 algorithms. In particular, GPU hardware 352 that supports 2D texture processing is used to perform 2D texture decompression 312 in order to decompress and recover the quantized values, in this example VQ indices. If the quantized values were encoded into RGB values during preprocessing, the quantized values may also be recovered from the RGB values. The 2D texture decompression 312 performed by the GPU hardware 352 may depend on the compressed 2D texture format that the compressed data is stored in. In particular, because the decompression can be carried out using the GPU hardware 352 on the fly with random data access, the need to use VRAM resources can be reduced or avoided. After the decompression, the recovered VQ indices are passed to the inverse VQ 314 functional block, which may be performed by the GPU shader 354.

Inverse quantization is then performed, which may depend on the quantization that was performed on the original spherical harmonics data. In this example, inverse VQ 314 is performed using the codebook (which is the same codebook used at VQ 302). Inverse VQ 314 takes the recovered VQ indices and information from the codebook (e.g., the global cluster centroids) to recover the spherical harmonics data.

The GPU shader 354 uses the recovered spherical harmonics data, together with other data (such as other Gaussian attributes stored in the 3DGS data structure and viewpoint data) to carry out 3D rendering 316 using 3DGS. The output of the 3D rendering 316 is a rendered 3D scene corresponding to the viewpoint data.

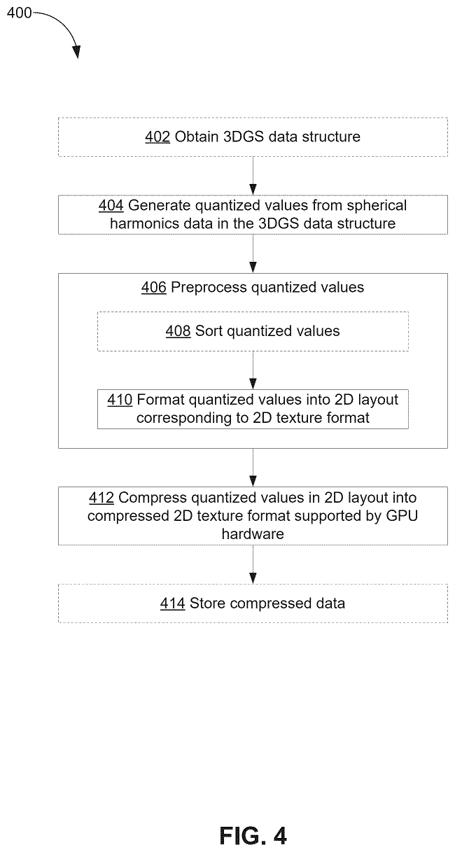

FIG. 4 is a flowchart illustrating an example method 400 for 3DGS data compression. The method 400 may be performed by the computing system 200, for example by the processing unit 204 of the computing system 200, to carry out the data compression illustrated in FIG. 3.

In some examples, the method 400 may include a step 402 at which a 3DGS data structure is obtained. For example, 3DGS data may be calculated from a set of 2D images representing a scene and may be stored in a 3DGS data structure (e.g., as shown in FIG. 1). In some examples, the method 400 may not include obtaining the 3DGS data structure, and instead the method 400 may start with the spherical harmonics data from a previously obtained 3DGS data structure.

At 404, a set of quantized values is generated from the spherical harmonics data of the 3DGS data structure. As described above with respect to FIG. 3, generating the set of quantized values may include performing VQ using a codebook, and the set of quantized values may be a set of VQ indices.

At 406, the set of quantized values is preprocessed. Preprocessing the set of quantized values includes at least step 410 and may optionally also include step 408. Optional step 408 and step 410 may be performed in an order other than that shown in FIG. 4, and may be performed as a single step, for example.

Optionally, at 408, the set of quantized values may be sorted, such that the quantized values, after being formatted into a 2D layout, are in numerical order. This may help to increase the spatial correlation in the 2D layout, which may reduce information loss during compression.

At 410, the set of quantized values is formatted into a 2D layout that corresponds to a 2D texture format. The 2D layout may be selected to have a size that is large enough to store all of the set of quantized values, such that the set of quantized values may be represented as a single 2D texture. For example, a texture size may have a defined texture height and width sufficient to store all the quantized values in the set of quantized values. Formatting the set of quantized values into the 2D layout may include encoding or converting each quantized value into an RGB value. Although an example of how a quantized value, in particular a VQ index, may be encoded into an RGB value is described above, it is not intended to be limiting and other ways of encoding or converting a quantized value into an RGB value may be used.

At 412, following the preprocessing, the set of quantized values in the 2D layout is compressed, using 2D texture compression compatible with the 2D texture format, into a compressed 2D texture format that is supported by the hardware of the GPU. For example, a block compression technique that generates a compressed texture format supported by the GPU may be used. A suitable block compression technique may be any one of BC1 to BC7, ASTC, or any one of DXT1 to DXT3, among others.

At 414, the compressed data may be stored. For example, the compressed data may be stored as a compressed 2D texture file. In some examples, the compressed data may be passed to the GPU for further processing and 3D rendering, without being stored.

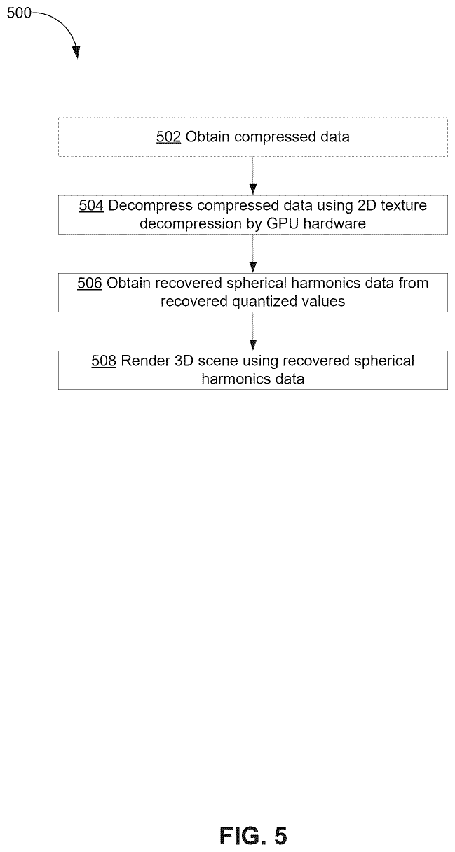

FIG. 5 is a flowchart illustrating an example method 500 for decompressing compressed data and rendering a 3D scene. The method 500 may be performed by the computing system 200, for example by a GPU in the processing unit 204 of the computing system 200, to carry out the data decompression and rendering illustrated in FIG. 3.

In some examples, the method 500 may be performed after the method 400, in order to decompress data compressed using the method 400 and perform rendering of a 3D scene. In some examples, the method 500 may immediately follow the method 400 (e.g., step 504 may follow step 412). In some examples, the method 500 may be performed some time in the future after the method 400 (e.g., the compressed data from the method 400 may be stored, and later retrieved to be used in the method 500).

In some examples, the method 500 may include a step 502 at which compressed data is obtained. For example, the compressed data may be obtained by retrieving the compressed data from local or remote storage. In some examples, the method 500 may not include obtaining the compressed data. The compressed data may be passed to the GPU by the CPU after the compressed data is generated, for example.

At 504, the hardware of the GPU is used to decompress the compressed data using 2D texture decompression to obtain a set of recovered quantized values (e.g., a set of recovered VQ indices, in examples where VQ was used to generate the quantized values). The hardware of the GPU may use random data access during decompression, thus avoiding or reducing usage of memory resources such as VRAM. While step 504 is performed by the hardware of the GPU, other steps of the method 500 may be performed by software of the GPU. For example, steps 506-508 may be performed by the GPU shader. The recovered quantized values may be passed directly to the GPU shader for further processing and 3D rendering, without being stored in VRAM.

At 506, recovered spherical harmonics data is obtained from the set of recovered quantized values. Recovering the spherical harmonics data may include performing inverse quantization on the recovered quantized values. For example, if VQ was used to generate the quantized values, then inverse VQ is performed. The codebook that was used for generating the VQ indices from the original spherical harmonics data (e.g., at step 404) is used for performing the inverse VQ.

At 508, a 3D scene is rendered using the recovered spherical harmonics data. Rendering the 3D scene may include obtaining other data from the 3DGS data structure other than the spherical harmonics data (e.g., the x, y, z coordinate data, scale data, rotation data, base color data and opacity data). This may be obtained by, for example, retrieving the other data from a memory. In some examples, other data from the 3DGS data structure may be compressed using other techniques (e.g., compressed in SPZ format) and obtaining the other data may include decompressing the other data. Viewpoint data may also be obtained (e.g., from memory or other input). The viewpoint data represents a viewpoint for which the 3D scene is to be rendered. The 3D scene may then be rendered, corresponding to the viewpoint, using the complete 3DGS data structure (including the recovered spherical harmonics data and the other data) and the viewpoint data.

The rendered 3D scene may then be outputted. For example, the rendered 3D scene may be outputted by the GPU to be displayed (e.g., on a display of the computing system).

Examples of the present disclosure provides an improved method for 3D rendering of a scene using 3DGS. Examples of the present disclosure have been found to reduce VRAM usage by more than 50% compared to conventional 3DGS rendering techniques (e.g., conventional techniques that do not use 2D texture compression), while maintaining at least similar levels of quality.

Examples of the present disclosure may be useful for any 3DGS rendering systems, including 3DGS rendering applications running on any computing system (e.g., server or client device). 3D rendering of large scenes and/or real-time 3D rendering (or other latency-sensitive rendering) may particularly benefit from examples of the present disclosure. 3D rendering applications that may benefit from example of the present disclosure include virtual scene navigation, 3D product display, 3D simulation for autonomous driving, 3D simulation for embodied AI, gaming applications, etc.

The present disclosure discusses compression of spherical harmonics data in 3DGS data structure, and may be used together with other techniques for compression of other 3DGS data. For example, data other than the spherical harmonics data may be compressed using any suitable technique, for example may be compressed into SPZ format, while the spherical harmonics data may be compressed using an example of the present disclosure.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

It should be understood that examples of the present disclosure may be embodied as a method, an apparatus, a non-transitory computer readable medium, a processing module, a chipset, a system chip or a computer program, among others. An apparatus may include a transmitting module configured to carry out transmitting steps described above and a receiving module configured to carry out receiving steps described above. An apparatus may include a processing module, processor or processing unit configured to control or cause the apparatus to carry out examples disclosed herein.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method comprising:
generating a set of quantized values from spherical harmonics data of a 3D Gaussian splatting (3DGS) data structure;
preprocessing the set of quantized values into a 2D layout that corresponds to a 2D texture format;
compressing the set of quantized values in the 2D layout, using 2D texture compression that is compatible with the 2D texture format, into a compressed 2D texture format that is supported by hardware of a graphics processing unit (GPU), to obtain compressed data; and
storing the compressed data.

2. The method of claim 1, further comprising:
decompressing, by the hardware of the GPU, the compressed data using 2D texture decompression to obtain a set of recovered quantized values;
obtaining recovered spherical harmonics data from the set of recovered quantized values; and
rendering a 3D scene using the recovered spherical harmonics data.

3. The method of claim 2, wherein the set of quantized values is a set of vector quantization (VQ) indices generated using VQ, wherein the set of recovered quantized values is a set of recovered VQ indices, wherein the recovered spherical harmonics data is recovered using inverse VQ on the recovered VQ indices, and wherein a codebook used for generating the set of VQ indices is also used for performing the inverse VQ.

4. The method of claim 2, wherein rendering the 3D scene comprises:
obtaining other data of the 3DGS data structure;
obtaining viewpoint data representing a viewpoint; and
rendering the 3D scene corresponding to the viewpoint using the recovered spherical harmonics data, the other data of the 3DGS data structure and the viewpoint data.

5. The method of claim 2, wherein the hardware of the GPU decompresses the compressed data using random data access.

6. The method of claim 1, wherein preprocessing the set of quantized values comprises:
sorting the quantized values, wherein the quantized values in the 2D layout are sorted numerically.

7. The method of claim 1, wherein the 2D layout is selected to have a size large enough to store the set of quantized values.

8. The method of claim 1, wherein preprocessing the set of quantized values comprises:
encoding each quantized value in the set of quantized values into an RGB value.

9. The method of claim 1, wherein the 2D texture compression is a block compression.

10. The method of claim 9, wherein the block compression is one of:
any one of block compression (BC) BC1 to BC7;
adaptive scalable texture compression (ASTC); or
any one of DirectX texture (DXT) DXT1 to DXT3.

11. The method of claim 1, further comprising:
obtaining the 3DGS data structure from a set of 2D images.

12. A computing system comprising:
a non-transitory memory; and
a processing unit configured to execute instructions stored in the non-transitory memory to cause the system to:
generate a set of quantized values from spherical harmonics data of a 3D Gaussian splatting (3DGS) data structure;
preprocess the set of quantized values into a 2D layout that corresponds to a 2D texture format;
compress the set of quantized values in the 2D layout, using 2D texture compression that is compatible with the 2D texture format, into a compressed 2D texture format that is supported by hardware of a graphics processing unit (GPU), to obtain compressed data; and
store the compressed data.

13. The computing system of claim 12, wherein the processing unit is configured to execute the instructions to further cause the system to:
decompress, by the hardware of the GPU, the compressed data using 2D texture decompression to obtain a set of recovered quantized values;
obtain recovered spherical harmonics data from the set of recovered quantized values; and
render a 3D scene using the recovered spherical harmonics data.

14. The computing system of claim 13, wherein the set of quantized values is a set of vector quantization (VQ) indices generated using VQ, wherein the set of recovered quantized values is a set of recovered VQ indices, wherein the recovered spherical harmonics data is recovered using inverse VQ on the recovered VQ indices, and wherein a codebook used for generating the set of VQ indices is also used for performing the inverse VQ.

15. The computing system of claim 13, wherein the processing unit is configured to execute the instructions to cause the system to render the 3D scene by:
obtaining other data of the 3DGS data structure;
obtaining viewpoint data representing a viewpoint; and
rendering the 3D scene corresponding to the viewpoint using the recovered spherical harmonics data, the other data of the 3DGS data structure and the viewpoint data.

16. The computing system of claim 13, wherein the hardware of the GPU decompresses the compressed data using random data access.

17. The computing system of claim 12, wherein the processing unit is configured to execute the instructions to cause the system to preprocess the set of quantized values by:
sorting the quantized values, wherein the quantized values in the 2D layout are sorted numerically.

18. The computing system of claim 12, wherein the processing unit is configured to execute the instructions to cause the system to preprocess the set of quantized values by:
encoding each quantized value in the set of quantized values into an RGB value.

19. The computing system of claim 12, wherein the 2D texture compression is a block compression that is one of:
any one of block compression (BC) BC1 to BC7;
adaptive scalable texture compression (ASTC); or
any one of DirectX texture (DXT) DXT1 to DXT3.

20. A non-transitory computer readable medium storing instructions thereon, wherein the instructions are executable by a processing unit of a computing system to cause the system to:
generate a set of quantized values from spherical harmonics data of a 3D Gaussian splatting (3DGS) data structure;
preprocess the set of quantized values into a 2D layout that corresponds to a 2D texture format;
compress the set of quantized values in the 2D layout, using 2D texture compression that is compatible with the 2D texture format, into a compressed 2D texture format that is supported by hardware of a graphics processing unit (GPU), to obtain compressed data; and
store the compressed data.
